(19) United States
(12) Patent Application Publication
(10) Pub. No.: US 2016/0235012 A1
(43) Pub. Date: Aug. 18, 2016

(54) Air Blower

(71) Applicant: Dan Fears, Middleburg Heights, OH (US)

(72) Inventor: Dan Fears, Middleburg Heights, OH (US)

(21) Appl. No.: 14/623,087

(22) Filed: Feb. 16, 2015

(51) Int. Cl. A01G 1/12; F04D 13/02; F04D 25/08; A47L 5/14

(52) U.S. Cl. CPC A01G 1/125; A47L 5/14; F04D 13/02; F04D 25/08

(57) ABSTRACT

An air blower that is operable to produce an airflow wherein the air blower has a first mode of operation and a second mode of operation. In the first mode of operation the air blower produces an airflow having a temperature that is approximately equal to that of its surroundings. In the second mode of operation, the air blower produces an airflow that has a temperature that is greater than that of its surroundings. The air blower consists of a motor providing mechanical energy to an electrical alternator. An ignition module is present being operable to start the motor. A first heating element and second heating element are present within the airflow path of the air blower. A bypass module is operable to select the first mode or second mode of operation. An insulated discharge tube is operable to direct the airflow produced by the blower motor.

### FIELD OF THE INVENTION

The present invention relates generally to debris removal devices, more specifically but not by way of limitation a debris removal device that is operable to have a first mode and a second mode wherein the first mode provides assistance in removal of a first type of debris and a second mode is present to provide removal of a second type of debris wherein in the second mode the debris removal device uses air that has been heated to a temperature that exceeds that of its external environment.

### BACKGROUND

Whether it is for cleaning up during the lawn care process or for removing debris from a desired area, conventional air blowers are routinely utilized by homeowners and professionals. As is known in the art, conventional air blowers utilize either an electric or gas motor that is coupled with a blower motor. As the electric or gas motor drives the blower motor, the air produced therefrom is directed through a discharge tube wherein the user places an end of the discharge tube proximate debris or other similar object to be removed.

One problem with conventional air blowers is their inability to effectively remove certain types of debris. Debris such as but not limited to snow accumulates in certain climates during the winter season and can present a challenge in the removal thereof. Currently most individuals rely on devices such as but not limited to snow shovels and/or snow blowers to remove snow from places such as but not limited to a driveway and/or a sidewalk. The need for additional implements such as a snow shovel or snow blower creates an additional expense for either the homeowner or the professional that is responsible for removing debris such as snow. Additionally, those individuals suffering from chronic maladies such as but not limited to lower back pain are unable to use items such as snow shovels.

Accordingly, there is a need for a blower that is operable to have a first mode and a second mode wherein the second mode provides effective removal of accumulated snow and the like through the utilization of discharged air that is warmer than that of its external surroundings.

### SUMMARY OF THE INVENTION

It is the object of the present invention to provide an air blower that is operable to remove a first type of debris and a second type of debris that utilizes a gas powered combustible engine.

Another object of the present invention is to provide an air blower that is operable to remove at least two types of debris wherein the second type of debris is snow.

A further object of the present invention is to provide an air blower that is operable to remove at least two types of debris wherein the air blower further includes an electrical generator.

Still another object of the present invention is to provide an air blower that is operable to remove debris wherein the air blower includes a blower motor operably coupled to the gas combustible engine and wherein the blower motor is operably coupled to a discharge tube.

An additional object of the present invention is to provide an air blower that includes a first heating element and a second heating element that are operable to heat the air passing through the discharge tube.

Yet a further object of the present invention is to provide an air blower operable to remove at least two types of debris wherein the second heating element is disposed within a removable section of the discharge tube.

Another object of the present invention is to provide an air blower that is operable to remove at least two types of debris that includes a bypass module that is operable to provide operation of the air blower in a first mode or a second mode.

Still a further object of the present invention is to provide an air blower that includes an ignition module for starting thereof.

An additional object of the present invention is to provide an air blower that is operable to remove at least two types of debris that is worn on a back of a user.

To the accomplishment of the above and related objects the present invention may be embodied in the form illustrated in the accompanying drawings. Attention is called to the fact that the drawings are illustrative only. Variations are contemplated as being a part of the present invention, limited only by the scope of the claims.

### BRIEF DESCRIPTION OF THE DRAWINGS

A more complete understanding of the present invention may be had by reference to the following Detailed Description and appended claims when taken in conjunction with the accompanying Drawings wherein:

FIG. 1 is a external view of the present invention engaged with a user; and

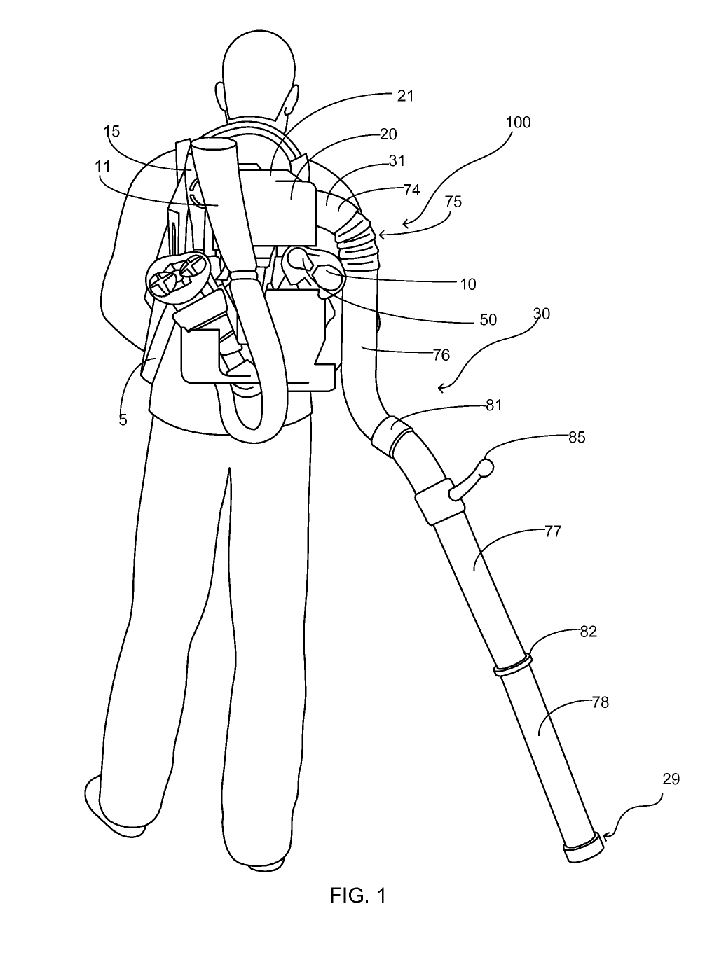

FIG. 2 is a detailed view of the discharge tube of the present invention; and

FIG. 3 is a diagrammatic view of the operational components of the present invention.

### DETAILED DESCRIPTION

Referring now to the drawings submitted herewith, wherein various elements depicted therein are not necessarily drawn to scale and wherein through the views and figures like elements are referenced with identical reference numerals, there is illustrated an air blower 100 constructed according to the principles of the present invention.

The air blower 100 includes a gas motor 10 that is operable to provide power to the air blower 100. The gas motor 10 is mounted to the frame 5 of the air blower utilizing suitable durable techniques. While no particular power output is required, good results have been achieved by utilizing a gas motor having an output of at least two horsepower. The gas motor 10 includes a conventional exhaust pipe 11. The gas motor 10 provides the mechanical energy input needed for the electrical alternator 15. The electrical alternator 15 is a conventional electrical alternator that produces electrical output from the mechanical input supplied by the gas motor 15. While not illustrated in detail herein, the electrical alternator 15 is a conventional electrical alternator that includes components such as but not limited to a stator, rotor, magnets and an exciter that are operable to produce an electric current. The electrical current output by the electrical alternator 15 is alternating current (AC) voltage.

The air blower 100 further includes a blower motor 20. The blower motor 20 is operably coupled to the gas motor 10 and is mechanically operated therefrom utilizing a conventional component such as but not limited to a drive shaft (not illustrated herein). The blower motor 20 is a conventional blower motor that includes components such as but not limited to a rotatable impeller or similar device that is operable to produce an airflow. The airflow that is produced by the blower motor 20 is directed towards and into the discharge tube 30 proximate end 31. While no particular velocity of discharge airflow is required, good results have been achieved by utilizing a blower motor 20 that produces an airflow within the range of eighty-five to one hundred and ninety miles per hour. The blower motor 20 is secured to the frame 5 utilizing suitable durable techniques and is encased within housing 21. While not illustrated herein, housing 21 includes an opening to allow thereinto to facilitate operation of the blower motor 20.

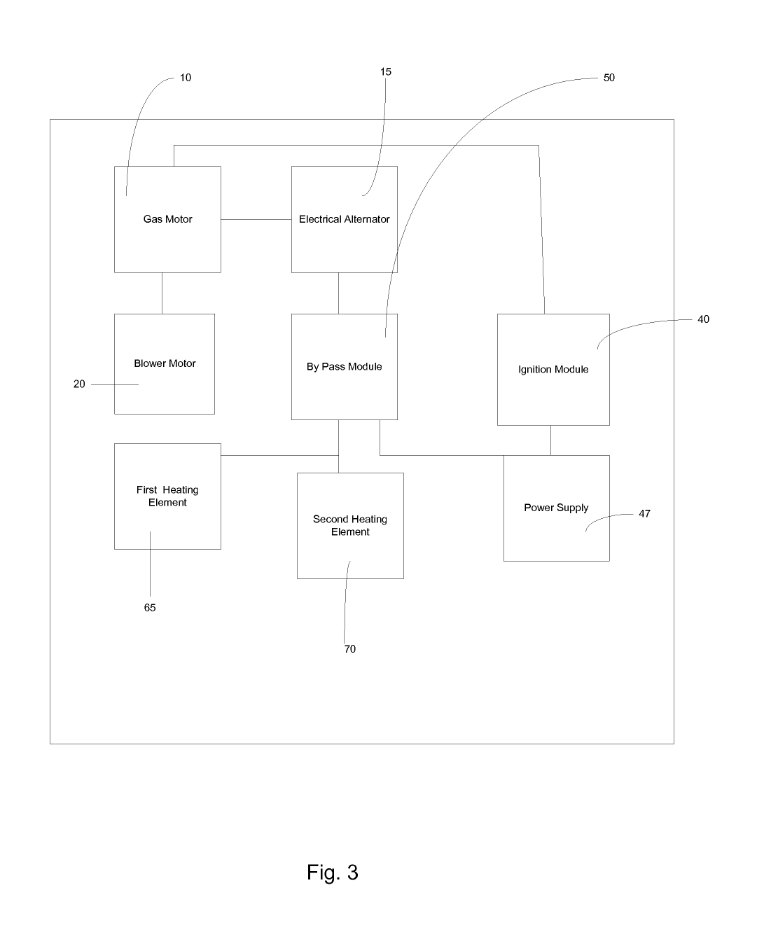

As shown in FIG. 3, that air blower 100 further includes an ignition module 40. The ignition module 40 is operably coupled to the power supply 45 and the gas motor 10 and provides a means to start and stop the gas motor 10. The ignition module 40 is a conventional electronic ignition module having the necessary electronics and user interface to supply power to start the gas motor 10. The power supply 47 is a conventional DC power supply and is operable to provide the necessary current to start the gas motor 10. It is contemplated within the scope of the present invention that the power supply 47 could be provided in numerous different sizes.

The electrical alternator 15 is operably coupled to a first heating element 65. The first heating element 65 is disposed within the discharge tube 30 proximate end 31. The first heating element 65 is manufactured from a nickel chromium alloy and is operable to heat the air passing through the discharge tube 30. The bypass module 50 functions to allow a user to place the air blower 100 in a first mode or a second mode. In the first mode, the air blower 100 is operable to produce an airflow through the discharge tube 30 wherein the air has a temperature that is approximately equivalent to its surroundings. In the first mode, the bypass module regulates the voltage produced from the electrical alternator 15 such that the voltage is not directed to the first heating element 65. In the second mode of the air blower 100, the bypass module 50 closes the circuit between the electrical alternator 15 and the first heating element 65 and second heating element 70 so as to provide electrical current thereto. In the second mode of operation, the air blower 100 is operable to produce an airflow through the discharge tube 30 wherein the air exiting end 29 of the discharge tube 30 is has a temperature that is greater than that of its surroundings. While no particular temperature for the air exiting the end 29 of the discharge tube 30 is required, good results have been achieved producing an airflow that has a temperature range of approximately one hundred and twenty five degrees to one hundred and seventy five degrees Fahrenheit as the airflow exits the discharge tube 30 at end 29. In the second mode of operation, the air blower 100 is utilized to remove accumulated snow and/or frozen precipitation from a desired area. The aforementioned temperature range is required to provide effective melting of the frozen precipitation while the airflow provides directional movement of the resulting water. The bypass module 50 is a conventional electronic module that contains the necessary electronics to provide regulation and direction of the electrical current to the first heating element 65 and second heating element 70.

The discharge tube 30 is operably coupled to the blower motor 20 is substantially hollow having a passage 71 therethrough. Air produced by the blower motor 20 travels through the discharge tube 30 and exits proximate end 29. The discharge tube 30 includes a flexible section 75 that facilitates the manipulation of the discharge tube 30 in both a lateral and up/down direction. The flexible section 75 is manufactured from a suitable durable material and is integrally formed with elbow 74 and first tube member 76. The first tube member 76 is constructed of a suitable durable material such as but not limited to plastic. The first tube member 76 is coupled with the second tube member 77 utilizing union 81. Union 81 is a conventional plastic fitting that utilizes threads and/or other conventional fastening techniques to provide the releasable securing of the first tube member 76 to the second tube member 77. A handle 85 is perpendicularly secured to the second tube member 77 and functions to provide an interface for a user to manipulate the direction of the discharge tube 30. Those skilled in the art will recognize that the handle 85 could be formed in numerous different shapes and secured in various locations along the discharge tube 30.

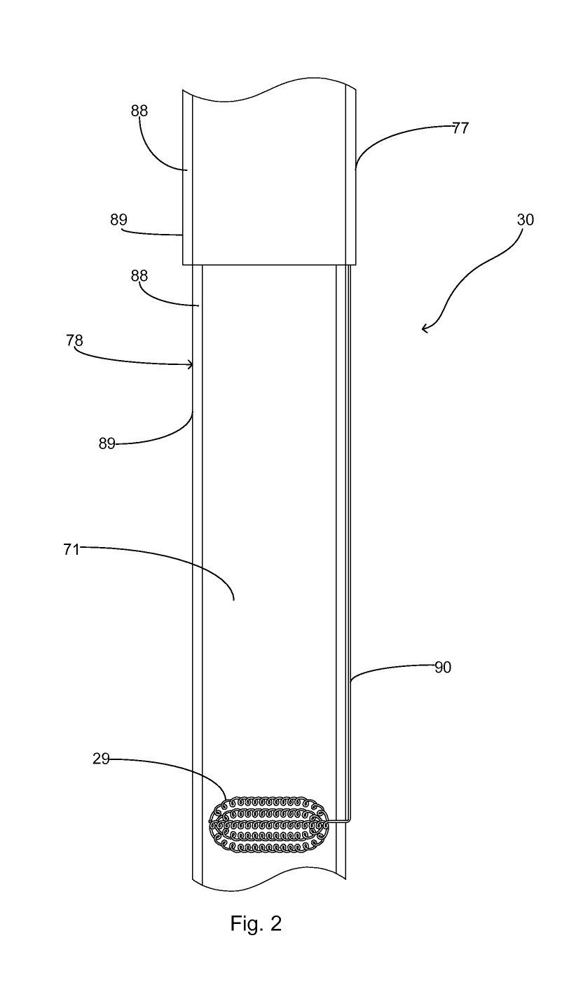

A third tube member 78 is releasably secured to the second tube member 77 utilizing union 82. Union 82 is a conventional slip-fit and/or threaded fitting that provides the releasable coupling of the third tube member 78 to the second tube member 77. As shown in particular in FIG. 2 herein, the second tube member 77 and third tube member 78 include an insulative layer 88 proximate the outer wall 89. The insulative layer 88 provides thermal protection so as to reduce the temperature reduction of the airflow as the air travels through passage 71. While no particular insulation material is required to produce the insulative layer 88, good results have been achieved utilizing mineral wool as it does not melt or support combustion. This is desirable given the proximity to the second heating element 70.

Still referring in particular to FIG. 2, the second heating element 70 is disposed within the passage 71 of the third tube member 78. The second heating element 70 receives current from the electrical alternator 15 when the air blower is placed in its second mode of operation. The second heating element 70 is manufactured from a suitable alloy such as but not limited to nickel chromium and functions to provide an additional heating source proximate end 29. The configuration of the second heating element 29 proximate the end 29 of the discharge tube 30 ensures that the air temperature of the airflow exiting the discharge tube 30 is within the aforementioned range during use of the air blower 100 in cold environments. The second heating element 70 is operably coupled to the electrical alternator 15 via wire 90. Wire 90 is a conventional coated copper wire operable to transmit electrical current. The bypass module 50 as previously discussed herein is electrically intermediate the second heating element 70 and the electrical alternator 15 so as to control the mode of operation of the air blower 100 in a first mode or a second mode.

While a first heating element 65 and a second heating element 70 have been disclosed herein, it is further contemplated within the scope of the present invention that the air blower 100 could utilize as few as one heating element or more than two heating elements to produce an airflow having the desired temperature as described herein.

Referring to the drawings submitted herewith, a description of the operation of the air blower 100 is a s follows. In use, a user will start the gas motor 10 utilizing ignition module 40. Subsequent the gas motor 10 being started the user will engage the bypass module 50 to select either a first mode or a second mode of operation. Ensuing a selection of mode of operation, a user will secure the frame 5 adjacent to their back and direct the discharge tube 30 in the desired direction.

In the preceding detailed description, reference has been made to the accompanying drawings that form a part hereof, and in which are shown by way of illustration specific embodiments in which the invention may be practiced. These embodiments, and certain variants thereof, have been described in sufficient detail to enable those skilled in the art to practice the invention. It is to be understood that other suitable embodiments may be utilized and that logical changes may be made without departing from the spirit or scope of the invention. The description may omit certain information known to those skilled in the art. The preceding detailed description is, therefore, not intended to be limited to the specific forms set forth herein, but on the contrary, it is intended to cover such alternatives, modifications, and equivalents, as can be reasonably included within the spirit and scope of the appended claims.

What is claimed is:

1. An air blower comprising:
a frame;
a gas motor, said gas motor secured to said frame;
an ignition module, said ignition module operably coupled with said gas motor and functioning to provide the starting and stopping thereof;
an electrical alternator, said electrical alternator operably coupled to said gas motor, said electrical alternator operable to produce an electric current;
a blower motor, said blower motor operably coupled to said gas motor, said blower motor operable to produce an airflow;
at least one heating element, said at least one heating element operably coupled to said electrical alternator, said at least one heating element being operable to provide an increase of temperature to the airflow; and
a bypass module, said bypass module being electrically coupled to said at least one heating element and said electrical alternator, said bypass module being operable to place the air blower in a first mode or a second mode of operation.

2. The air blower as recited in claim 1, wherein in said first mode the air blower is operable to produce an airflow that has a temperature that is approximately equal to the temperature of the external surroundings of the air blower.

3. The air blower as recited in claim 2, wherein in said second mode the air blower is operable to produce an airflow having a temperature that is greater than that of its surroundings.

4. The air blower as recited in claim 3, and further including a discharge tube, said discharge tube being operably coupled to said blower motor, said discharge tube having an outer wall and a hollow passage being operable to direct air from said blower motor.

5. The air blower as recited in claim 4, wherein said discharge tube further includes an insulative layer, said insulative layer being proximate said outer wall of said discharge tube, said insulative layer operable to provide thermal insulation of the passage.

6. The air blower as recited in claim 5, and further including a power supply, said power supply operable to provide power to the air blower.

7. The air blower as recited in claim 6, wherein said insulative layer is manufactured from mineral wool.

8. An air blower operable to produce an airflow that has a temperature that is greater than that of its surroundings comprising:
a frame;
a motor, said motor secured to said frame, said motor operable to provide the mechanical energy input required to operate the air blower;
an ignition module, said ignition module operably coupled with said motor, said ignition module containing the necessary electronics to provide the starting and stopping thereof;
an electrical alternator, said electrical alternator operably coupled to said motor, said electrical alternator operable to produce an electric current;
a blower motor, said blower motor operably coupled to said motor, said blower motor operable to produce an airflow;
a plurality of heating elements, said plurality of heating elements operably coupled to said electrical alternator, said plurality of heating elements being operable to provide an increase of temperature to the airflow;
a bypass module, said bypass module being electrically coupled to said plurality of heating elements and said electrical alternator, said bypass module containing the necessary electronics to place the air blower in a first mode or a second mode of operation; and
a discharge tube, said discharge tube having a plurality of releasably secured sections, said discharge tube having an outer wall and a hollow passage, said discharge tube operable to provide directional control of airflow exiting the air blower.

9. The air blower as recited in claim 8, wherein at least one of said plurality of heating elements is disposed within the passage of said discharge tube.

10. The air blower as recited in claim 9, wherein in said first mode the air blower is operable to produce an airflow that has a temperature that is approximately equal to the temperature of the external surroundings of the air blower.

11. The air blower as recited in claim 10, wherein in said second mode the air blower is operable to produce an airflow having a temperature that is greater than that of its surroundings.

12. The air blower as recited in claim 11, wherein said discharge tube further includes an insulative layer, said insulative layer operable to provide thermal insulation between the passage of the discharge tube and the external environment of the air blower.

13. The air blower as recited in claim 12, wherein said first mode and said second mode the air blower is operable to produce an airflow exiting the discharge tube wherein the airflow is at least 90 miles per hour.

14. The air blower as recited in claim 13, wherein during the second mode of operation of the air blower the airflow exiting said discharge tube has a temperature between the range of 125 to 175 degrees Fahrenheit.

15. An air blower that is operable in a first mode and a second mode wherein the temperature of the airflow exiting the air blower in said second mode is different than that of the temperature of the air exiting the air blower in said first mode comprising:
a frame;
a motor, said motor secured to said frame, said motor operable to provide the mechanical energy input required to operate the air blower;
an ignition module, said ignition module operably coupled with said motor, said ignition module containing the necessary electronics to provide the starting and stopping thereof;
an electrical alternator, said electrical alternator operably coupled to said motor, said electrical alternator operable to produce an electric current;
a blower motor, said blower motor operably coupled to said motor, said blower motor being disposed within a housing, said blower motor operable to produce an airflow;
a discharge tube, said discharge tube having a plurality of releasably secured sections, said discharge tube having an outer wall and a hollow passage, said discharge tube operable to provide directional control of airflow exiting the air blower
a first heating element, said first heating element disposed within said housing of said blower motor, said first heating element being in fluid communication with the airflow exiting said blower motor, said first heating element operable to increase the temperature of the airflow exiting the blower motor;
a second heating element, said second heating element being disposed within the hollow passage of said discharge tube, said second heating element electrically coupled with said electrical alternator, said second heating element operable provide an increase of temperature to the airflow exiting said discharge tube;
a bypass module, said bypass module being electrically coupled to said first heating element and said second heating element and said electrical alternator, said bypass module containing the necessary electronics to place the air blower in a first mode or a second mode of operation; and
wherein in said second mode of operation the air blower produces an airflow exiting from said discharge tube having a temperature that is greater than that of its surroundings.

16. The air blower as recited in claim 15, wherein in said first mode the air blower is operable to produce an airflow that has a temperature that is approximately equal to the temperature of the external surroundings of the air blower.

17. The air blower as recited in claim 16, wherein said discharge tube further includes an insulative layer, said insulative layer operable to provide thermal insulation between the passage of the discharge tube and the external environment of the air blower.

18. The air blower as recited in claim 17, and further including an electrical wire, said electrical wire being secured to said discharge tube, said electrical wire providing the operational connection between said second heating element and said bypass module.

19. The air blower as recited in claim 18, wherein said insulative layer is manufactured from mineral wool.

20. The air blower as recited in claim 19, wherein during the second mode of operation of the air blower the airflow exiting said discharge tube has a temperature between the range of 125 to 175 degrees Fahrenheit.
